(19) United States
(12) Patent Application Publication
(10) Pub. No.: US 2005/0017825 A1
(43) Pub. Date: Jan. 27, 2005

(54) Method and system for high-speed communication over power line

(76) Inventor: Ake Hansen, Karlstad (SE)

Correspondence Address: Steven Payne, 8027 ILIFF Drive, Dunn Loring, VA, 22027, US

(21) Appl. No.: 10/851,761

(22) Filed: May 24, 2004

(30) Foreign Application Priority Data
Nov. 21, 2001 (SE) 0103901-5

(51) Int. Cl. H01P 3/00

(52) U.S. Cl. 333/242; 340/310.01

(57) ABSTRACT

A communication system for transmission of data signals over a power line is disclosed. The system comprises at least one data generating arrangement, transceivers and line couplers for coupling data to the power line. The system comprises a microwave transmitter between the transceiver and the line coupler, which transceives the data signal as an electrical field on a surface of the power line.

### TECHNICAL FIELD OF THE INVENTION

The present invention relates to a communication system for transmission of data signals over a power line comprising at least one data generating arrangement, transceivers and line couplers for coupling data to said line power.

### BACKGROUND OF THE INVENTION

The applicant has developed a solution for transforming the power line network into a high-class information infrastructure capable of handling the high demands that users and network operators have on the next generation IP-based multimedia services. The technology is in a suite of products ranging from plug and play end-user modems to reliable and robust network infrastructure. The benefits of using the power line network for communication is that the network is already in place and that it is omni-present, a normal house has power sockets in almost every corner. To the user, this means, for example convenient and cost effective Internet access,

Thus, a new method for transmitting digital information over the mains network and/or distribution network is provided. The schematic view of FIG. 1 illustrates an example of a solution provided by the applicant. In a first step, shown in block A, information, such as digital, voice and/or image data is modulated and transformed onto the mains distribution network in a medium voltage transformer. Before supplying the power to household, it is transformed into low voltage electricity, i e. block B, in a low voltage transformer. At the user's premises, e.g. a house, the information on the power line is transformed to suitable data by means of modems connected directly to the power line, block C.

Prior art fails to disclose an arrangement according to the invention. In, for example, U.S. Pat. No. 6,243,571 is disclosed a method and system for the reception, conversion and distribution of wireless communication signals received from such communication devices as PCS, Cellular, and Satellite over AC power lines commonly found within a building, office, home or other structure is disclosed. This invention specifically provides for the distribution of wireless signals In structures where otherwise signal degradation and/or blockage are common. Moreover, this invention takes advantage of the existing AC power lines to create a communication channel avoiding the necessity of rewiring the building or other structure. This invention provides important improvements to the signal coverage and reception of wireless transmitted signals within buildings and other structures and does so in an efficient and cost effective manner. This invention does not consider high voltage power lines (main lines) hanging over the ground, which means that the Invention cannot be applied in such applications.

### SUMMARY OF THE INVENTION

Thus, there is need for an arrangement for transferring data from a data source onto the power transmission line. The arrangement according to the present invention allows fast data transmission, high transmission efficiency (low attenuation), and possibility to communicate over long distances in both one and two way communications.

For these reasons, wherein the system comprises a microwave transmitter between said transceiver and said line coupler, which transceivs said data signal as electrical field on a surface of said power line.

According to one aspect of the invention, the transmitter comprises microwave antennas connected to the transceiver and said line coupler. The antenna is a parabolic reflector antenna. The antenna comprises a dish, a coaxial connector, a feeder, a feeder dipole, and a primary reflector. The incoming and outgoing microwave signals are excited by said dipole and reflected towards the primary reflector aiming to the dish. Preferably, there is a direct path to the dish from the dipole, to obtain a very narrow beam pointing out in a substantially tapering lobe from the dish. The lobe has an angle of approximately about 0.5 to 2.0 degrees.

According to another aspect of the invention, the transmitter comprises a dielectric wave-guide. The wave-guide comprises wave-guide horns at each end and a dielectric wave-guide part. An injected signal, injected by a λ/4 probe, to one side of said wave-guide is transferred by means of said dielectric wave-guide to the wave-guide horn to the other side and a corresponding probe in it. The reflections in the wave-guide appear due to the different dielectric properties between the wave-guide (polyethylene) and the surrounding air.

Most advantageously, the coupler is a Goubau horn, which comprises a substantially conical body, a compartment section, having an end section with a small opening for passage of said power line, a wall with an aperture, and an external connection part. The space between the end section and the wall builds a cavity functioning as bandpass filter. The conical body functions as matching horn. A coupling loop is arranged coaxially to the external connection part.

The transceiver comprises a base-band processor, on the transmitter side: a mixer modulator, an IF stage, mixer, amplifier, on the receiver side: a mixer demodulator, an IF stage, mixer, amplifier, a duplexer, a first oscillator and a second oscillator synthesizer. The base band processor prepares data for transmitting and receiving and handles the preambles package sizing and CRC, the mixer (modulator/demodulator), on the TX side the base band signal is modulated and lifted to the intermediate frequency as the IF signal to a higher power signal, on the RX side: the if signal is demodulated to the base band frequency, microwave amplifier amplifies the low level signal to a higher power signal, IF-stage is a high amplification stage, the front-end amplifier is a low noise Input amplifier that will increase the signal, the first oscillator is used to lift the base band frequency to the IF-frequency on the TX side and the opposite on the RX side, the second oscillator, synthesizer mixes the IF signal to the carrier frequency on the TX side and the opposite on the RX side, the synthesizer selects different oscillator frequency for different carrier frequencies, and the duplexer distinguishes between TX frequencies and RX frequencies and combines them towards the antenna output.

The microwave transmitter is connected to a cavity working as a bandpass filter.

The invention also relates to a method in a communication system for transmission of data signals over a power line, the system comprising at least one data generating arrangement, transceivers and line couplers for coupling data to said line power. The method comprises the step of arranging a microwave transmitter between said transceiver and said line coupler.

### SHORT DESCRIPTION OF THE DRAWINGS

The invention is described with reference to a number of embodiments illustrated In attached drawings, in which:

FIG. 1 is a block diagram of transmission system,

FIG. 2 is a general block diagram of the invention,

FIG. 3 is a block diagram of a first embodiment of the invention,

FIG. 4 is a block diagram of a transceiver,

FIG. 5 is a cross-sectional view of an antenna arrangement,

FIG. 6 is a cross-sectional view of a line coupler,

FIG. 7 is a block diagram of a second embodiment of the invention,

FIG. 8 is a cross-sectional view of a wave-guide arrangement, and

FIG. 9 is a block diagram of a connection example.

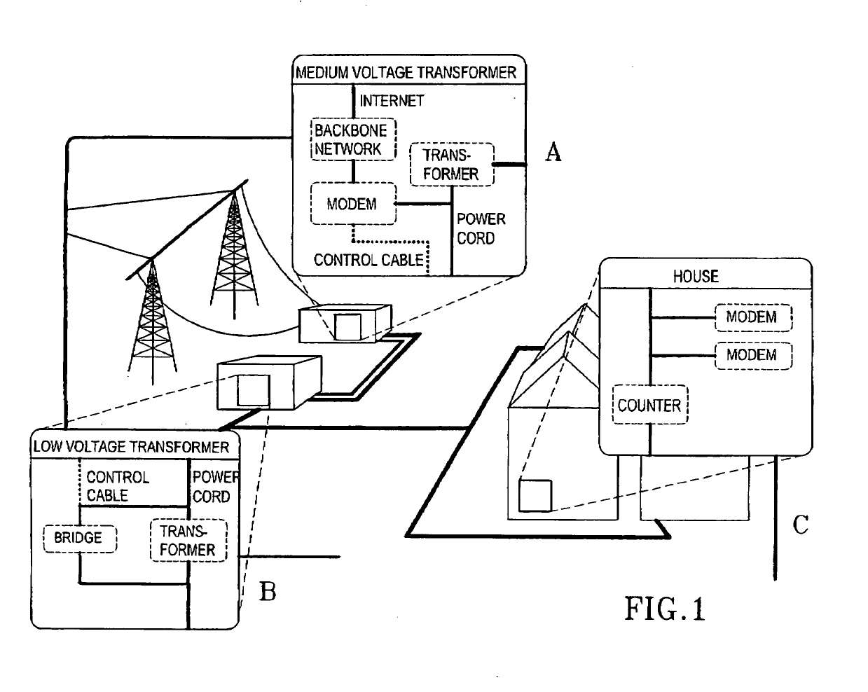

### DETAILED DESCRIPTION OF THE EMBODIMENTS

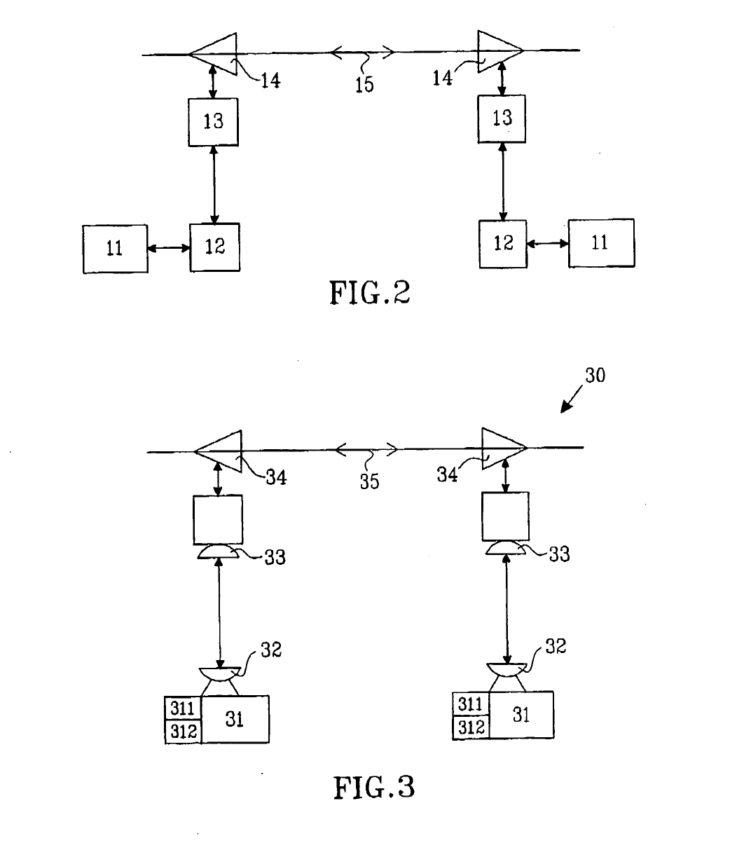

Block diagram of FIG. 2, illustrates the main parts of a transmission system 10 according to the present invention. The system comprises, at both transmitter (T) and receiver (R) sides, a Communication Manager (CM) 11, a Communication Manager Transceiver (CMT) 12, a Link Transceiver (LT) 13 and a Line Coupler (LC) 14. A signal transmission is made over the power line 15.

A more detailed block diagram of the system according to the Invention according to a first embodiment Is illustrated in FIG. 3. In the drawings similar reference numerals refer to similar functional units.

In the system 30, the CM 31 comprises a media converter 311 and a server computer 312. The media converter 311 translates the signal between, e.g. optical fibres to electrical conductors. The server 312 handles, for example higher levels of protocols when connecting to several networks and stacks the data information if possible. It also can manage the remote monitoring of other devices.

The CMT 32 and LM 33 are used for data information preparation for redundant communication. It also modulates/demodulates data signal from, e.g., binary to analogue, having high frequency properties by means of a base band processor and necessary analogue RF, preferably microwave modules. Mixers, oscillators and amplifiers utilize these modules. The function of CMT and LM is assumed to be known by a skilled person.

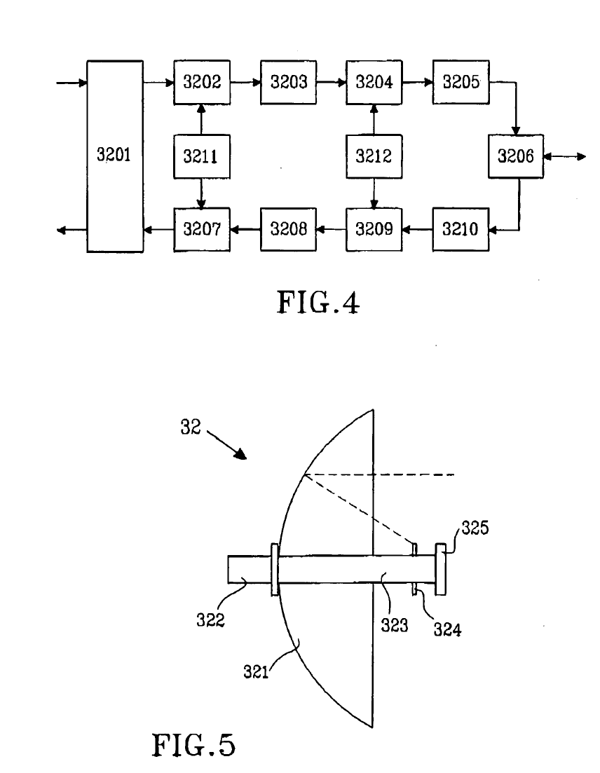

In the following a CMT 32 is described, as an example, bearing in mind that the LM 33, consists of same parts. Referring to FIG. 4, the CMT 32 comprises a base-band processor 3201, on the transmitter side: a mixer modulator 3202, an IF stage 3203, mixer 3204, amplifier 3205 (for u-wave); on the receiver side; a mixer demodulator 3207, an IF stage 3208, mixer 3209, amplifier 3210 (front end). CMT also comprises a duplexer 3206,a first oscillator 3211 and a second oscillator synthesizer 3212.

The base band processor prepares data for transmitting and receiving and handles the preambles package sizing and CRC. In the mixer (modulator/demodulator), on the TX side, the base-band signal is lifted and modulated to the intermediate frequency as the IF signal to a higher power signal; on the RX side, the IF signal is shifted and demodulated to the base band frequency. A microwave amplifier amplifies the low level signal to a higher power signal. On TX-side, IF-stage is a high amplification stage. The front-end amplifier is a low noise input amplifier that will increase the signal. The first oscillator is used to lift the base band frequency to the IF-frequency on the TX side and the opposite on the RX side (shift down). The second oscillator, synthesizer mixes the IF signal to the carrier frequency on the TX side and the opposite on the RX side. The synthesizer selects different oscillator frequency for different carrier frequencies. The duplexer distinguishes between TX frequencies and RX frequencies and combines them towards the antenna connection.

According this embodiment, the communication between the transceivers is performed by means of antennas 32 and 33; preferably microwave antennas of known type, for broadband communication. A microwave signal is fed or received through the microwave antennas. The main lobe of the microwave antenna 32 is directed towards the power line cable, which is equipped with another microwave antenna 33.

FIG. 5 illustrates an exemplary embodiment of a parabolic reflector antenna 32. The antenna comprises a dish 321, a coaxial connector 322, a feeder 323, a feeder dipole 324, and a primary reflector 325.

Incoming and outgoing microwave signals 326 are excited by the dipole 324 and reflected towards the primary reflector 325 aiming to the dish 321. There is also a direct path to the dish from the dipole. The purpose of this solution is to obtain a very narrow beam pointing out in a “pencil” like lobe from the dish, approximately with an angle of about 1 to 1.5 degrees.

The microwave antenna is connected to a cavity working as a band pass filter. The produced electrical RF field, orthogonal to the cable surface is prolonged along the cable through an opening of the cavity into a line coupler, such as a Goubau horn.

FIG. 6 illustrates a cross-sectional view through a Goubau horn 14. The horn comprises a substantially conical body 141 and a compartment section 142. The compartment section has an end section 143 with a small opening for the passage of the power wire 15, a wall 145 with an aperture 146, and an external connection part 147. The space between the end section 143 and the wall 145 builds a cavity 148 functioning as a bandpass filter. The conical body 141 functions as matching horn. A coupling loop 149 is arranged coaxially to the external connection part 147.

The external connection part 147 works as an input/output for the microwave signals. It can be connected to a parabolic dish antenna (e.g. as described above) or other isolated waveguide. The cavity/bandpass filter 148 is the connecting link between a ground link to the power wire 15. It filters the noise and disturbances outside the frequency pass band. The coupling loop or a λ/4 probe is a coupling device, which transfers the RF-energy into the cavity. The aperture 146 is a substantially circular opening surrounding the wire that will leak the energy out onto the surface of the wire. The matching horn 141 is the unit that expands the E-field from the aperture and releases the E-field as a standing wave on the surface of the wire and matches the impedance to suppress standing waves in the injection point.

Using the antennas and the horn, the RF energy is then transmitted or received along the power line. The Goubau horn matches the cavity impedance to the cable impedance, thus a minimum of reflection occurs. The microwave antenna is connected to a cavity working as a band pass filter. The created electrical RF field, orthogonal to the cable surface is prolonged along the cable through an opening of the cavity into the Goubau horn. The RF energy is then transmitted or received along the power line. The Goubau horn matches the cavity impedance to the cable impedance such that minimum of reflections occurs,

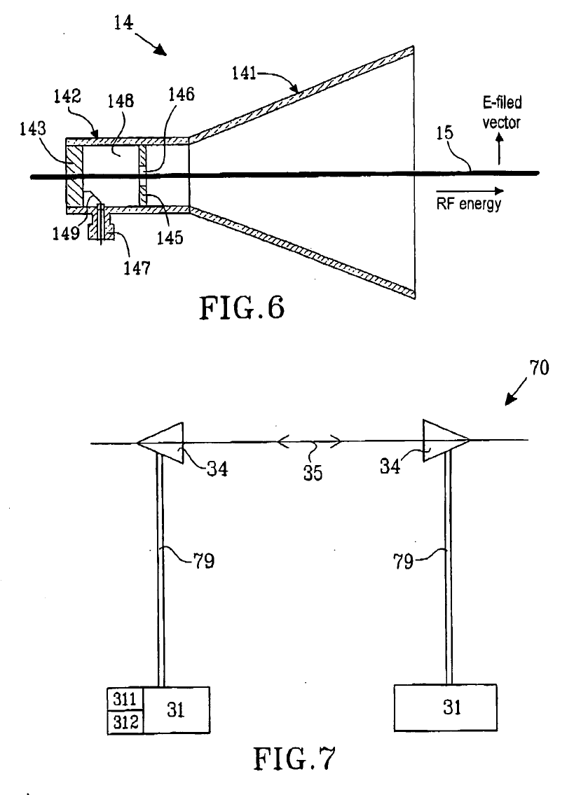

Using microwave antennas is only one way of transmitting signals between the transceivers and the couplers. In the embodiment of FIG. 7, the system 70 comprises a microwave guide 79 to transmit the information between the transceiver 31 and the line coupler 34. Functional units having same function as in FIG. 3 are designated with same reference numbers.

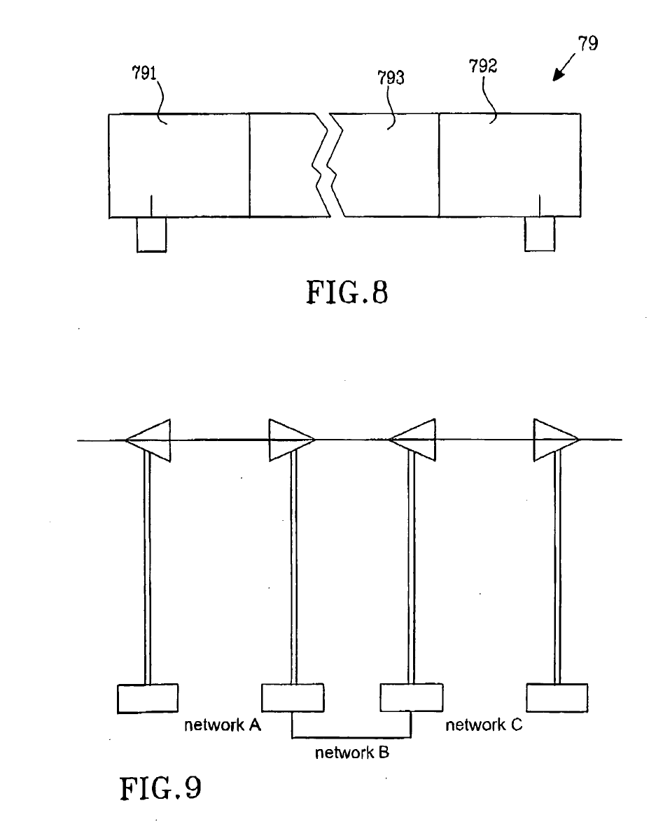

FIG. 8 illustrates an embodiment of a dielectric wave-guide. The wave-guide 79 comprises wave-guide horns 791 and 792 at each end and a dielectric wave-guide part 793, An injected RF-signal injected by a λ/4 probe to one side is transferred by means of the dielectric wave-guide to the wave-guide horn to the other side and a corresponding probe in it. Reflections in the wave-guide appear due to the different dielectric properties between the wave-guide (polyethylene) and the surrounding air.

Thus, the microwave signal is fed through an open wave-guide into the dielectric wave-guide and transformed between the line couplers. This solution is more efficient compared to the antenna solution, because the leakage through the guide surface Is less than the antenna transmission. Attached to the power line is the other part of the dielectric wave-guide, which is completed with another open wave-guide.

FIG. 9 illustrates an embodiment wherein a number of transceiver systems are connected, providing a repeater system. The repeater system can be arranged as a system with taps along the line with high voltage wires. Every tap is equipped with complete back-to-back transceivers with a possibility to drop data information to the data network, here network B.

The invention is not limited to the shown embodiments but can be varied In a number of ways, e.g. through combination of two or more embodiments shown, without departing from the scope of the appended claims and the arrangement and the method can be implemented in various ways depending on application, functional units, needs and requirements etc.

1-22. cancelled.

23. A communication system for transmission of data signals over a power line comprising at least one data generating arrangement, transceivers and line couplers for coupling data to said power line, wherein the system comprises a microwave transmitter between said transceiver and said line coupler, which transceives said data signal as an electrical field on a surface of said power lines.

24. The system according to claim 23, wherein said transmitter comprises microwave antennas connected to said transceiver and said line coupler.

25. The system according to claim 23, wherein said antenna is a parabolic reflector antenna.

26. The system according to claim 25, wherein said antenna comprises s dish, a coaxial connector, a feeder, a feeder dipole, and a primary reflector.

27. The system according to claim 26, wherein incoming and outgoing microwave signals are excited by said dipole and reflected towards the primary reflector aiming to the dish.

28. The system according to claim 27, wherein there is a direct path to the dish from the dipole, to obtain a very narrow beam pointing out in a substantially tapering lobe from the dish.

29. The system according to claim 27, wherein said lobe has an angle of approximately about 0.5 to 2.0 degrees.

30. The system according to claim 23, wherein said transmitter comprises a dielectric wave-guide.

31. The system according to claim 30, wherein said wave-guide comprises wave-guide horns at each end and a dielectric wave-guide part.

32. The system according to claim 31, wherein an injected signal, injected by a Lambda/4 probe, to one side of said wave-guide is transferred by means of said dielectric wave-guide to the wing-guide horn to the other side and a corresponding probe in it.

33. The system according to claim 32, wherein reflections in the wave-guide appear due to the different dielectric properties between the wave-guide (polyethylene) and the surrounding air.

34. The system according to claim 23, wherein said coupler is a Goubau horn.

35. The system according to claim 34, wherein said Goubau horn comprises a substantially conical body, a compartment section, having an end section with a small opening for passage of said power line, a wall with an aperture, and an external connection part.

36. The system according to claim 35, wherein the space between the end section and the wall builds a cavity functioning as a bandpass filter.

37. The system according to claim 35, wherein the conical body functions as a matching horn.

38. The system according to claim 35, wherein a coupling loop is arranged coaxially to the external connection part.

39. The system according to claim 23, wherein said transceiver comprises a base-band processor, on the transmitter side: a mixer modulator, a first IF stage, a first mixer, a first amplifier; on the receiver side: a mixer demodulator, a second IF stage, a second mixer, a second amplifier, a duplexer, a first oscillator and a second oscillator synthesizer.

40. The system according to claim 39, wherein the base band processor prepares data for transmitting and receiving and handles the preambles package sizing and CRC, the mixer (modulator/demodulator), on the transmitter side the base band signal is modulated and lifted to the intermediate frequency as the IF signal to a higher power signal; on the receiver side: the IF signal is demodulated to the base band frequency, microwave amplifier amplifies the low level signal to a higher power signal, the second IF stage is a high amplification stage, the front end amplifier is a low noise input amplifier that will increase the signal, the first oscillator is used to lift the base band frequency to the IF-frequency on the transmitter side and the opposite on the receiver side, the second oscillator, synthesizer mixes the IF signal to the carrier frequency on the transmitter side and the opposite on the receiver side, the synthesizer selects a different oscillator frequency for different carrier frequencies, and the duplexer distinguishes between transmitter frequencies and receiver frequencies and combines then towards the antenna output.

41. The system according to claim 23, wherein the microwave transmitter is connected to a cavity working as a bandpass filter.

42. The system according to claim 23, wherein produced electrical radio frequency field, orthogonal to a surface of said power line is prolonged along said line through an opening of the cavity into a line coupler.

43. The system according to claim 23, wherein the electrical field is released as a standing wave on the surface of the line.

44. A method in a communication system for transmission of data signals over a power line, the system comprising at least one data generating arrangement, transceivers and line couplers for coupling data to said line power, the method comprising the step of arranging a microwave transmitter between said transceiver and said line coupler.
